(19) United States
(12) Patent Application Publication
(10) Pub. No.: US 2009/0065412 A1
(43) Pub. Date: Mar. 12, 2009

(54) Apparatus for waste water treatment

(76) Inventors: Rahma Mbarki, Montreal (CA); Martin Groleau, Tring-Jonction (CA)

Correspondence Address: PHILIP SWAIN, PHD;C/O GOWLING LAFLEUR HENDERSON, 1 PLACE VILLE MARIE,, 37TH FLOOR, MONTREAL, QC, H3B 3P4, CA

(21) Appl. No.: 11/898,225

(22) Filed: Sep. 11, 2007

(51) Int. Cl. C02F 3/30

(52) U.S. Cl. 210/151; 210/170.08; 210/170.06; 210/532.2

(57) ABSTRACT

The present invention is directed towards an anaerobic reactor useful for purifying waste water. The reactor comprises a chamber with a first water inlet for receiving a volume of waste water and a first water outlet connectable to a biofilter. A number of interdigitated baffle walls are arranged in the chamber and define a water passageway between the first water inlet and the first water outlet.

### FIELD OF THE INVENTION

The present invention concerns waste water treatment, and more particularly to an apparatus for treating waste water.

### BACKGROUND OF THE INVENTION

In urban environments, households are usually connected to centralized waste water treatments systems. In rural or recreational areas, isolated households, or households in small communities without central waste water treatment systems, must install independent waste water treatment systems.

Traditionally, waste water treatment systems include a septic tank, and a leaching bed. Waste waters will then percolate through the ground. In these systems, a portion of the waste water is processed by bacterial action in the septic tanks, while the remainder is processed in the leaching bed and absorbed by the underlying sand and soil. Contaminants from such septic systems include bacteria, viruses, detergents and other domestic cleaning products which can penetrate subsoil water. These phenomena can create serious contamination problems. Despite that cesspools and traditional septic systems are well known contamination sources, they are often poorly monitored and little studied. Also, in specific geographical areas, local geological structure makes it impossible to install a leaching bed. Waste water treatment solutions that do not require a leaching bed must then be contemplated.

The aforesaid problems have been addressed using a number of waste water treatment designs. U.S. Pat. No. 6,200,470, issued on Mar. 13, 2001 to Romero et al. for “Sub-soil domestic waste water treatment apparatus having multiple aeration chambers” This patent discloses a subterranean septic tank including at least three chambers separated by at least two walls. The waste waters appear to enter into the first chamber, which is aerated by fine bubbles, which increases decomposition activity of the aerobic bacteria therein. The waste waters flow through an opening in the first wall to reach the second aeration chamber which also includes fine bubbles. The waste waters appear to become progressively clearer and then flow through a decanting chamber, or directly towards the exit, although other aeration chambers may be added. No aeration is done in the decanting chamber, which allows the solid particles to fall towards the bottom in a clear liquid to escape through the exit. Oblique walls located at the bottom return the falling solid particles to the second chamber so their decomposition can continue.

U.S. Pat. No. 6,749,745 discloses a waste water treatment system in the form of a filtering hose. The filtering hose is used at the exit of a septic tank as an aeration station. The interior substance is a foam allowing the water to circulate therein, but which is dense enough to cause capillary effect and limit the displacement speed of the water. The foam has an open upper portion, where the air inside the hose communicates with the external air. The waste waters fill only part of the foam, and the air combined with the turbulence caused by the foam maximizes the fluid's aeration conditions and promotes the proliferation of the bacterial colonies. The waste waters exiting the hose are sent to a purification field.

U.S. Pat. No. 6,638,420, issued on Oct. 28, 2003 to Tyllila for “Apparatus for sewage treatment” discloses a waste water treatment system for use in ships. The main tank comprises two aeration chambers, where the air is provided to allow for substantial biological disintegration. The chambers are separated by walls. The waste waters from the second aeration chamber are then transferred to a decanting chamber where the heaviest particles accumulate at the bottom. The solid particles thereby accumulated are pumped and returned to the first chamber to continue their degradation. The clarified surface waters of the decanting chamber are directed to a disinfection chamber, where a chemical agent or ultraviolet radiation completes the treatment. The waters treated in this manner can then be stored or evacuated.

U.S. Pat. No. 6,440,304 discloses a filtration hose at the exit of a septic tank. A filtering material such as shredded used tires, sand, gravel or polystyrene, whose larger particles are located upstream and whose smaller particles are located downstream, is located in the stream to promote the development of the bacterial culture. The system can be used as an intermediate between a septic tank and a purification field, or to replace the latter completely.

U.S. Pat. No. 6,406,619, issued on Jun. 18, 2002 to Donald et al. for “Three stage sewage treatment” discloses a septic tank with three chambers. The tank comprises a first decanting chamber where the waste waters are directed and where the anaerobic bacteria begin decomposition. The most fluid part of the waste waters, between the surface where solids float and the bottom where solids accumulate, then flows into the second chamber. The second chamber has an external compartment, where the waters are subjected to air bubbles. The waters enter into a clarifier located at the center of the second chamber by its bottom opening. In the clarifier, there are no air bubbles, which allows the solid waste to fall towards the bottom and to return to the external compartment. The fluid leaving the clarifier is substantially “clean”, and then flows through a sterilizing chamber, where chlorine, for example, is added to disinfect the fluid.

The aforesaid systems require complex installations, and often require a sterilization system before water can be rejected. They also do not combine aerobic/non aerobic cycles, and do not provide flow control mechanisms in the final stages of the process, which can cause irregularities in the quality of the rejected waters.

### SUMMARY OF THE INVENTION

We have made the new and surprising discovery that an anaerobic waste water treatment reactor with a number of interdigitated baffle walls provides unexpected waste water purification when used with an aerobic biofilter. Advantageously, this development has been used to create a new autonomous waste water treatment apparatus which significantly reduces or essentially eliminates the problems associated with the aforesaid systems, and operates by gravity. Furthermore, the apparatus provides domestic waste water treatment that meets the most stringent governmental norms, and does so without the need for a leaching bed before the final release of the treated water. Our system, with its non-aerobic flow controlled by baffles, with its non aerobic chamber used also as a flow regulating device, and with its linear aerobic biological reactor increases significantly the quality of the rejected water, while ensuring a continuum in the quality of the waste water over time.

According to an embodiment of the present invention, there is provided an anaerobic reactor for purifying waste water, the reactor comprising:
a) a chamber having a first water inlet for receiving a volume of waste water and a first water outlet connectable to a biofilter; and
b) a plurality of interdigitated baffle walls arranged in the chamber so as to define a water passageway between the first water inlet and the first water outlet,

Typically, the chamber includes a chamber roof and a chamber floor, a first plurality of spaced apart baffle walls extending away from the chamber floor and a second plurality of spaced apart baffle walls depending away from the chamber roof. The interdigitated baffle walls define a plurality of compartments in fluid communication with each other. The chamber roof includes three spaced apart baffle walls and the chamber floor includes three spaced apart baffle walls, the baffle walls defining three compartments in fluid communication with each other. The baffle walls support anaerobic bacterial growth thereon. Typically, the biofilter is located downstream of the first water outlet for receiving water from the water passageway. The biofilter includes a conduit located exterior of the chamber, the conduit having a second water inlet and a second water outlet, the second water inlet being connected to the first water outlet. An air supply is connected to the conduit for supplying air into the conduit, the air being supplied in an amount sufficient to support aerobic growth of bacteria. The conduit includes an amount of a filtration medium disposed therein. The air supply supplies a volume of microbubbles into the conduit. In one example, the air supply is heatable. In one example, the conduit is serpentine. The conduit surrounds the chamber and is disposed orthogonal to the ground. In another example, a recycling pump is connected to the second water outlet for re-injecting the water into the conduit. Typically, a septic tank is connected to the first water inlet. A recycling pump is connected to the septic tank, the chamber or the biofilter. The biofilter is located in a container away from the chamber. The baffle walls control the transit time of waste water through the chamber.

Accordingly in another embodiment, there is provided a biofilter for use with an anaerobic reactor, the biofilter comprising:
a) a conduit having a water inlet and a water outlet, the water inlet being connectable to the anaerobic reactor;
b) an air supply connected to the conduit for supplying air into the conduit, the air being supplied in an amount sufficient to support aerobic growth of bacteria in the conduit; and
c) an amount of a filtration medium disposed in the conduit for filtering particulate material.

In one example the conduit is serpentine.

In one aspect, there is provided an apparatus for purifying waster water, the apparatus comprising:
a) an anaerobic reactor including a chamber having a first water inlet for receiving a volume of waste water and a first water outlet connected to a biofilter;
b) a plurality of interdigitated baffle walls arranged in the chamber so as to define a water passageway between the first water inlet and the first water outlet;
c) an aerobic biofilter connected to the first water outlet, the biofilter being a conduit having an amount of a filtration medium located therein; and
d) an air supply connected to the conduit for supplying air into the conduit, the air being supplied in an amount sufficient to support aerobic growth of bacteria.

### BRIEF DESCRIPTION OF THE DRAWINGS

Further aspects and advantages of the present invention will become better understood with reference to the description in association with the following Figures, wherein:

FIG. 1 is a perspective view of an embodiment of a waste water treatment apparatus of the invention;

FIG. 2 is a perspective cut away view of the waste water treatment apparatus;

FIG. 3 is a cross section view of the waste water treatment apparatus;

FIG. 4 is a detailed perspective view of an aerobic biofilter; and

FIG. 5 is a diagrammatic representation of a stand-alone aerobic biofilter.

### DETAILED DESCRIPTION OF THE INVENTION

The present invention concerns an apparatus, which we call a BioArray, for biologically processing waste waters from isolated households as well as from small or large scale commercial, industrial, or agricultural operations. The waste waters are rich in organic matter which can be indirectly measured by the biochemical (biological) oxygen demand (BOD). The apparatus, which is described in detail below, has a number of advantages over existing waste water treatment apparatuses. It is easy to install with low maintenance, low cost, few controls, and safe for the user. The apparatus can be manufactured using long lasting, low cost plastic material.

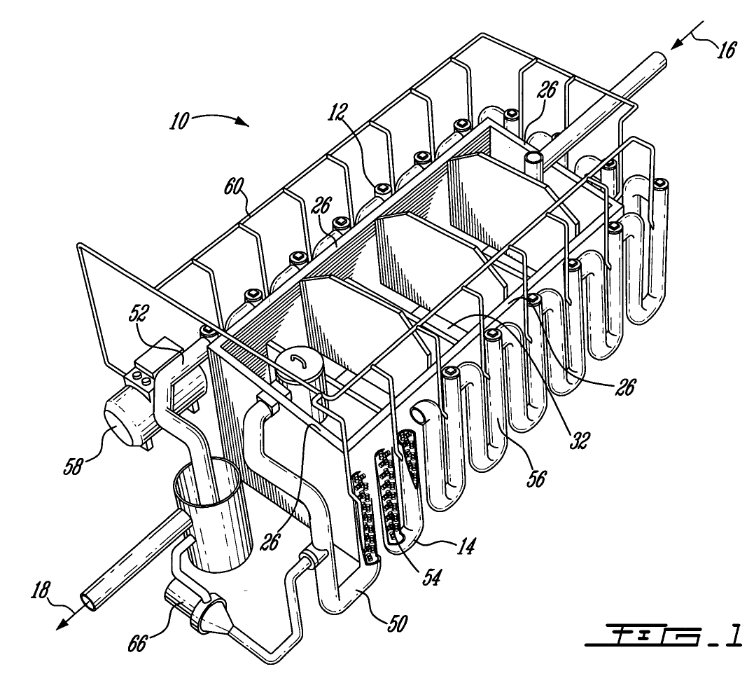

Referring now to FIG. 1, in which an apparatus of the present invention is shown generally at 10. Broadly speaking, the apparatus comprises an anaerobic reactor 12 for purifying waste water and an aerobic biofilter (also called a trickling filter) 14. A septic tank (not shown) is a source of a volume of waste water 16 which is fed into the anaerobic reactor 12. A purified water outlet 18 is located downstream of the septic tank. Thus the septic tank, the anaerobic reactor 12 and the aerobic biofilter 14 are connected in series with each other. The septic tank is conventional and allows the settling of solid materials and the retention of floating elements using a filter. The septic tank provides for preliminary decantation and digesting of the waste water. The septic tank receives all the waste water created by the connected users (including toilets, showers, sinks, dishwashers, washing machine and so on), and separates liquid from solids, and provides a preliminary breakdown of organic matter in the wastewater.

As best illustrated in FIGS. 1, 2 and 3, the anaerobic reactor 12 comprises a chamber 20 to which is fluidly connected a first water inlet conduit 22 for receiving the volume of waste water 16 from the septic tank and a first water outlet conduit 24, which is connectable to the biofilter 14. The chamber 20 is typically a rectangular-shaped container having four sidewalls 26, a chamber roof 28 and a chamber floor 30, although the chamber may be any other shape. A plurality of interdigitated baffle walls 32 are arranged inside the chamber 20. Typically three baffle walls 32a are connected to the chamber roof 28 and depend downwardly therefrom and three baffle walls 32b are connected to the chamber floor 30 and project upwardly therefrom. The baffle walls 32a and 32b are spaced apart and are disposed towards into the gaps between each baffle wall thereby creating the interdigitation. The interdigitation of the baffle walls 32 defines a water passageway 34 which creates vertical flows as the volume of water flows along the passageway 34 between the first water inlet conduit 22 and the first water outlet conduit 24. The arrangement of the interdigitated baffle walls 32 creates a number of compartments 36, 38, and 40 which are each in fluid communication with each other. The location of each of the baffle walls 32a and 32b creates gaps 34a and 34b respectively between the baffle walls and the chamber roof 28 and the chamber floor 30. Since the reactor 12 is non-aerated, it serves as an anaerobic biological reactor. Furthermore, owing to the baffle walls 32, the chamber 20 is a regulation tank, which ensures that the flow of the pre-processed waste water from the septic tank along the passageway 34 will not exceed the reactor's 12 capacity and that the water, which reaches the end of the reactor 12, has a controlled transit time.

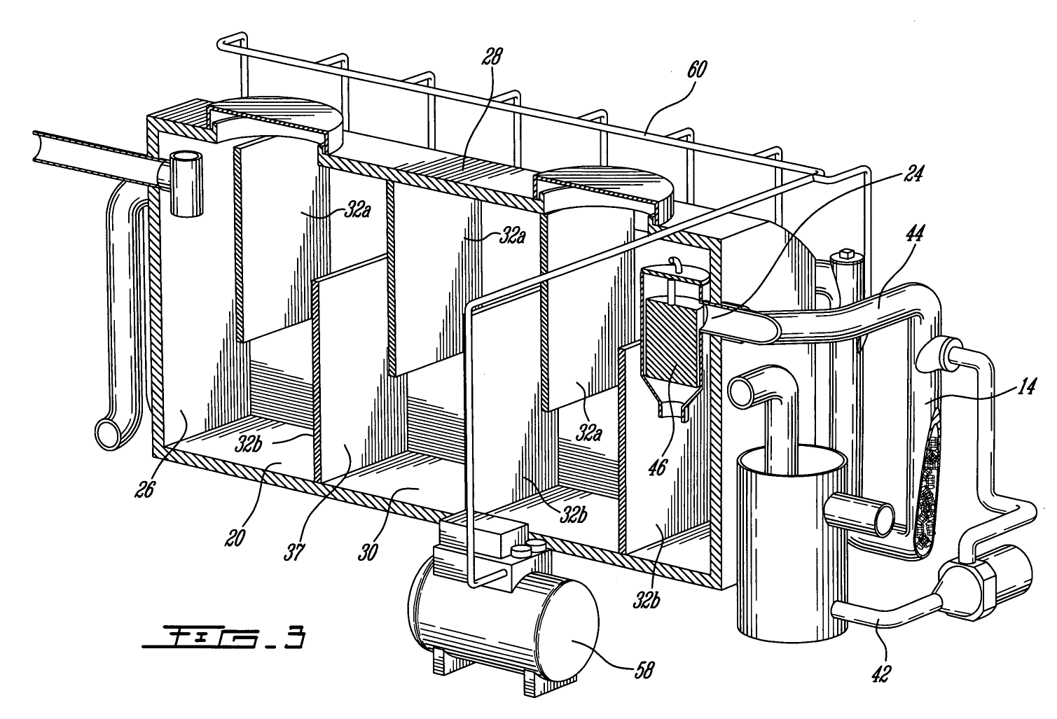

As best illustrated in FIG. 3, the baffle walls 32 also act as a support medium for anaerobic bacteria proliferation and growth. The bacteria which participate in the purification process may include nitrosominous, nitrobacters, and the like. Other suitable bacteria or corresponding enzymes, whether naturally present in the waste water or introduced from an outside source, may be used according to the present invention. These bacteria are attached onto the surface area 37 of the baffle walls 32 and are used to biologically treat waste water. This increases the bacterial activity and significantly reduces or essentially eliminates the creation of sludge. Furthermore, the baffle walls 32 can also be used with different design and shapes, and may include textured surfaces, as a support for bacteria growth.

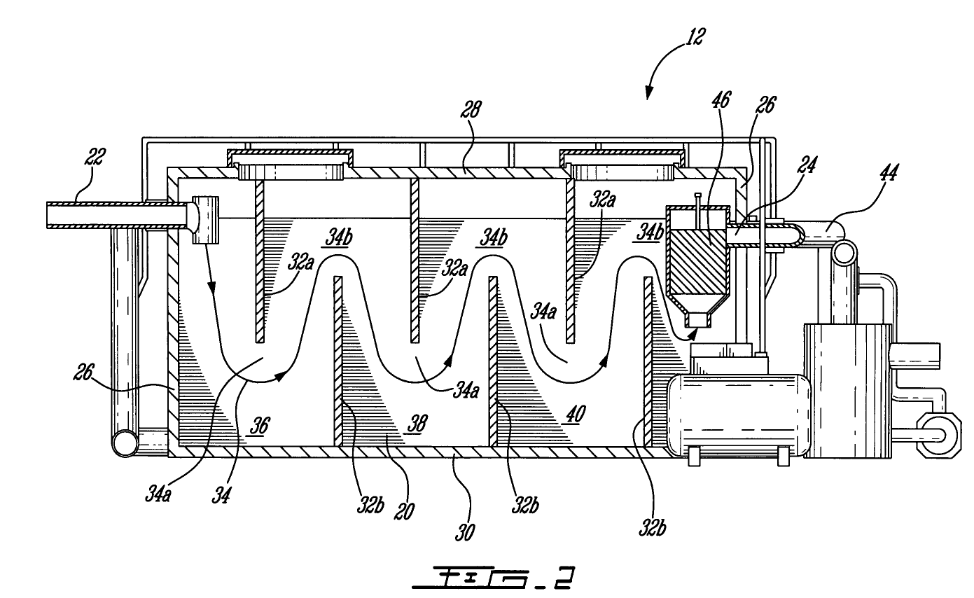

Referring now to FIG. 2, the first water outlet conduit 24 includes two escape conduits disposed at different heights relative to each other. A lower conduit 42 is connected to the biofilter 14 and regulates water flow thereinto, and an upper conduit 44 acts both as an overflow and also feeds water directly into the biofilter 14. A filter 46 is located at the downstream end of the reactor 12 and is used to retain particles over 0.8 mm in diameter before water is transferred to the biofilter 14. One skilled in the art will recognize that the size and capacity of the filter 46 will depend on requirements for the apparatus.

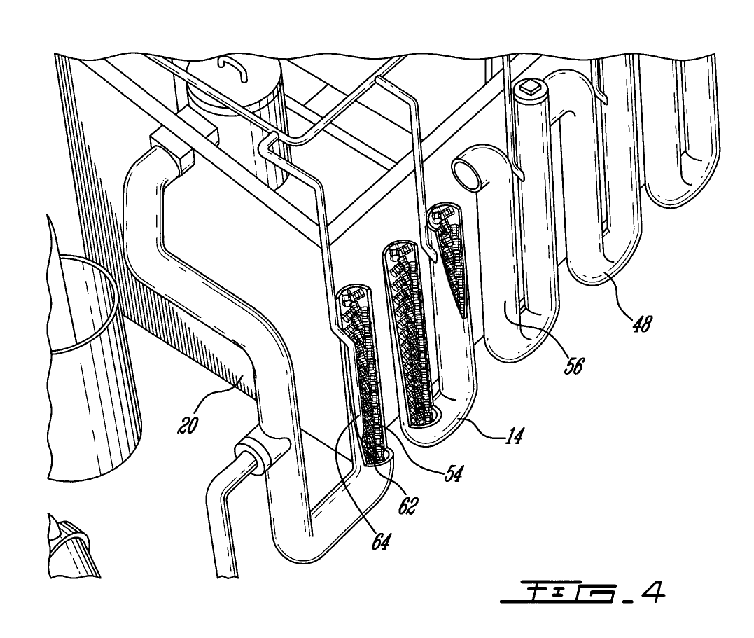

Referring now to FIGS. 1 and 4, the biofilter 14 is located downstream of the first water outlet conduit 24 for receiving water from the water passageway 34. The biofilter 14 includes a conduit 48 which is located around the exterior of the chamber 20. The conduit 48 is located adjacent to three of the sidewalls 26 of the chamber 20. The conduit 48 has a second water inlet 50 and a second water outlet 52. The second water inlet 50 is in communication with the first water outlet 24. An amount of a filtration medium 54 is located inside the conduit 14. Examples of typical filtration media 54 material are known to those skilled in the art and include, but is not limited to, Aquamat, Kaldness biomedia, Biomate filter media and the like. Every filtration media constitutes a small biological reactor, a substrate with large surface area on which bacteria responsible for the oxidation of the dissolved organic material will adhere and grow. This biological system does not require replacement of its filtration media and offers a minimum maintenance system where organic solids are fully digested, eliminating the requirement of frequent pumping of residual sludge required in most existing systems. Filtration media can be manufactured in non-toxic, non-biodegradable material. Different shapes and material can be used.

Still referring to FIGS. 1 and 4, the conduit 48 is typically a serpentine pipe, which serves to increase the time in which the water flowing therethrough is in contact with the filtration medium 54. The conduit 48 includes a plurality of interconnecting columns 56 each of which may be filled with an amount of the filtration medium 54. The columns 56 are disposed generally orthogonal to the ground.

Referring now to FIGS. 1, 3 and 4, an air pump 58 is connected to the biofilter 14 via a series of lines 60. The lines 60 are connected to a lower portion 62 of each column 56 of the conduit 48 and provide an air supply into the biofilter 14 thereby creating an aerobic environment via a set of diffusing nozzles, perforated lines (pipes) 64, or any air diffusing mechanism, as best illustrated in FIG. 4. The air diffusing mechanism 64 ensures a uniform distribution of air on the surface of the filtration media 54 as well as in the waste water itself. The air is supplied in amounts that are sufficient to support aerobic growth of bacteria. The oxidation of the organic matter is accompanied by bacterial growth which must be regulated to avoid accumulation of bacterial matter that could drop out of filtration media 54 when BOD charge is heavy, and plug formation in the biofilter mass. The auto regulation of the biomass is achieved using multiple aerated columns of the biofilter 14. The controlled management of the bacterial growth eliminates the need for a sludge separation device. The air supply does not need to feed all columns 56 of the biofilter 14 and will depend on the expected BOD load. For use in cold climates, the air supply may be heatable to allow continued use of the apparatus throughout the year. In the biofilter 14, the biological reduction of the waste water is performed by a biofilm created by the aerobic bacteria adhering to the filtration media 54. In the biofilter 14, the air pump injects 58 micro air bubbles, creating an oxygen rich environment where bacteria will thrive and consume the remaining BOD. Also, the movement created by the air bubbles virtually eliminates any risk of obstruction, thereby minimizing system maintenance requirements.

As best illustrated in FIG. 1, a recycling pump 66 is connected to the second water outlet 52 for re-injecting the water into the conduit 48. The recycling pump 66 is used to take the water at the end of the biofilter 14 and to re-inject a portion of it into the first column 56, or indeed any other column, of the biofilter. The re-injection can also be done in the septic tank, or the anaerobic reactor 12.

This invention also provides an improved apparatus which promotes aerobic and anaerobic bacterial growth. The bacteria are classified as aerobic if dissolved oxygen is needed and anaerobic if they oxidize organic matters in the absence of dissolved oxygen. Facultative bacteria like E. Coli are able to function either in the presence or absence of dissolved oxygen.

As illustrated in FIG. 1, the biofilter 14 is shown located around the anaerobic reactor 12 which would be a suitable configuration for an off ground installation. However, an in-ground apparatus is also contemplated in which the biofilter 14 is located away from the the anaerobic apparatus 12 in a separate container.

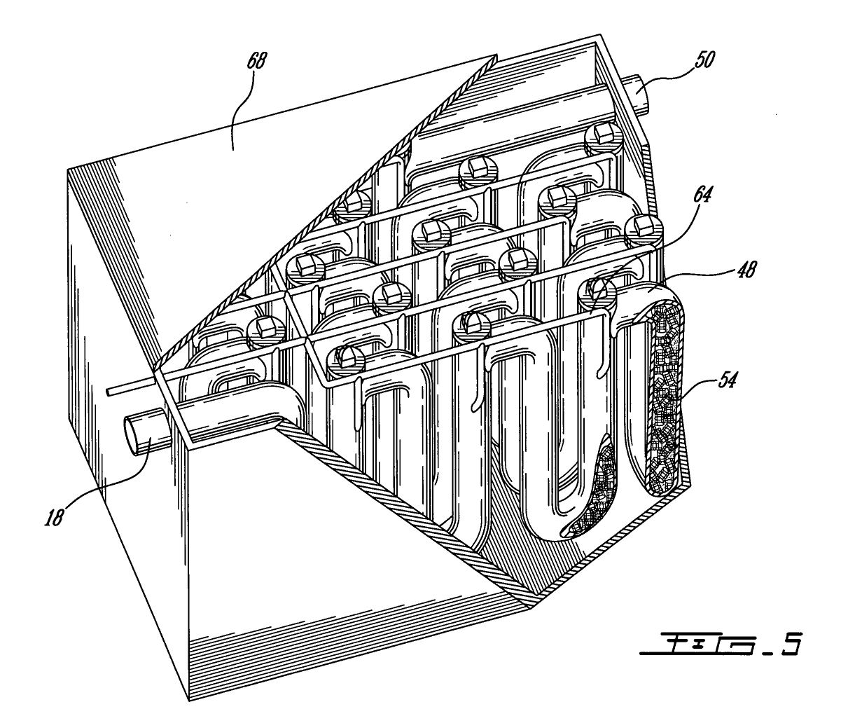

As illustrated in FIG. 5, the biofilter 14 may also be located away from the anaerobic reactor 12. As a separate stand-alone component, the biofilter 14 may be connectable to a water outlet of any type of anaerobic reactor. After the water exits the anaerobic reactor, it flows into the serpentine conduit 48 via the water inlet 50 and flows therealong in the direction of the arrows and exits the biofilter at the purified water outlet 18.

The apparatus 10 is designed to process biodegradable organic matters. To ensure optimum performance, introducing into the system non-biodegradable materials such as for example polymers, sand, glass and the like should be avoided. When present, these materials will be trapped by the septic tank which should be regularly inspected and cleaned when required.

The apparatus 10 uses the capability of naturally present bacteria, which may be used in combination with additional bacterial solutions added to the drainage solution to enhance the efficiency of the process. The biological activity is, however, not immediate, and requires a maturation phase of two to three weeks before the treatment system, especially the biofilter, reaches its optimum treatment capacity. This is due to the fact that the filtration media 54 have yet to be coated with the bacteria film. It is through a permanent immersion of the drainage solution that bacteria will progressively adhere to the media to form the biofilm. If required, the injection of bacterial culture can be used for newly installed systems in order to boost the treatment capacity of the reactors at the beginning.

The injection can be done manually or using an automatic pump programmed to inject bacterial culture. The quantity and frequency of bacterial culture injection can be calibrated as a function of the expected waste volumes. The bacterial culture injection can be done either in the septic tank or in the anaerobic reactor 12 or both of them.

Also contemplated is an assembly of the biofilter 14 (the trickling filter) in the form of an array of columns. The biofilter is an assembly where columns are installed sequentially from the first to the last column. Each column as an entry that receives flow of the drainage solution, and an exit connected to the entry of the following column (in alternance top to bottom and bottom to top). Increase in capacity of the trickling filter can be easily achieved by either increasing the section of columns in the array, or by installing multiple arrays of columns in parallel.

### Operation

With reference now to FIGS. 1 and 2, an operation of the apparatus 10 will now be described. Waste water containing impurities is introduced into the apparatus 10 from the septic tank via the first water inlet 22. The water moves along the water passageway 32 in the direction of the arrows in the chamber 12, as shown in FIG. 2. The bacteria located on the surface of the baffle walls 32 digests the biological material suspended in the water. A drainage solution exits the anaerobic reactor 12 via the filter 46 and the first water outlet 24, and flows by gravity into the first column 56 of the biofilter 14. While moving throughout the biofilter 14, the water is aerated by the air bubbles, which creates continual movement in the columns 56. This movement increases the contact time between the filtration media 54 and the water and ensures a homogeneous distribution of the bacterial film on the filtration media 54, thereby increasing the overall treatment capacity of the apparatus. Once the water has flowed through the biofilter 14, it exits the biofilter via the purified water outlet 18.

The apparatus uses bacteria attached to either the anaerobic reactor or the aerobic biofilter to grow and eliminate impurities from the water present therein. The impurities include without limitation, BOD, nitrates and phosphates.

### EXAMPLE

The apparatus 10 has been used to treat waste water generated by three residences of the same building land having 6 people on a permanent basis. The daily flow averaged is 2, 160 liters per day. The corresponding minimum volume for both septic tank and second reactor is 4.8 cubic meters each. The total media spread in the trickling filter of 36 columns comprised 750 sq. meters. The waste water was, after treatment, clean enough to be discharged.

The results obtained by the system configured as above are as follows:

| Sampling | | Outflow Septic | Outflow |
|---|---|---|---|
| date | Parameters | Tank | BioArray |
| Week 1 | BOD5 (mg/ml) | 82 | 10 |
| | Suspended matter | 49 | 12 |
| | (mg/ml) | | |
| | Fecal coliforms | 2,100,000 | 11,000 |
| | (UFC/100 ml) | | |
| Week 2 | BOD5 (mg/ml) | 107 | 3 |
| | Suspended matter | 23 | 4 |
| | (mg/ml) | | |
| | Fecal coliforms | 120,000 | 4,600 |
| | (UFC/100 ml) | | |
| Week 3 | BOD5 (mg/ml) | 178 | 12 |
| | Suspended matter | 58 | 5 |
| | (mg/ml) | | |
| | Fecal coliforms | 900,000 | 2,100 |
| | (UFC/100 ml) | | |
| Week 4 | BOD5 (mg/ml) | 62 | 6 |
| | Suspended matter | 73 | 5 |
| | (mg/ml) | | |
| | Fecal coliforms | 3,300,000 | 140 |
| | (UFC/100 ml) | | |
| Week 5 | BOD5 (mg/ml) | 69 | <2 |
| | Suspended matter | 28 | 3 |
| | (mg/ml) | | |
| | Fecal coliforms | 1,200,000 | <10 |
| | (UFC/100 ml) | | |
| Week 6 | BOD5 (mg/ml) | 95 | <2 |
| | Suspended matter | 34 | 2 |
| | (mg/ml) | | |
| | Fecal coliforms | 900,000 | <10 |
| | (UFC/100 ml) | | |
| Week 7 | BOD5 (mg/ml) | 78 | <2 |
| | Suspended matter | 36 | 2 |
| | (mg/ml) | | |
| | Fecal coliforms | 130,000 | <10 |
| | (UFC/100 ml) | | |
| Week 8 | BOD5 (mg/ml) | 63 | <2 |
| | Suspended matter | 26 | 3 |
| | (mg/ml) | | |
| | Fecal coliforms | 4,400,000 | <10 |
| | (UFC/100 ml) | | |
| Week 9 | BOD5 (mg/ml) | 85 | <2 |
| | Suspended matter | 72 | 1 |
| | (mg/ml) | | |
| | Fecal coliforms | 250,000 | <10 |
| | (UFC/100 ml) | | |

### Government Standards (Province of Quebec)

| Parameter | Norm |
|---|---|
| BOD5 (mg/ml) | 15 mg/ml |
| Suspended matter (mg/ml) | 15 mg/ml |
| Fecal coliforms (UFC/100 ml) | 50,000 |

In the above tables, the abbreviation UFC refers to Unités Formant Coliformes or Units of Fecal Coliforms. It measures the fecal coliforms (in colonies or units).

The above data indicates that the water treated by the present invention presents a much greater quality than that of most government standards. Quebec standards are among the most stringent in North America. The BNQ test will likely become a norm in Canada in the coming years. There is a remarkable absence of coliforms in the water treated with the apparatus of the present invention and which is more than 5000 times less than that of the required norm. As demonstrated from the results herein, this exceptional quality of treated water allows its reuse after minor disinfection for many residential needs like showers, pools, washing, irrigation or other non drinking domestic usages. If not reused, it can be rejected in water courses without adverse effect to the fauna and the flora.

The system may also be used for nitrification/denitrification.

The apparatus 10 is capable of purifying water at an exceptional rate of more than 99%, as shown hereinabove. With respect to the protection of environment and preservation of water resources, the apparatus 10 allows evacuating water of very high quality which may cleanse the phreatic surface into which it may be discharged by dilution effect.

In addition, per meter square, the apparatus 10 is one of the less costly water treatment devices on the market and it can be used as a low cost solution for any type of wastewater treatment application, whether residential or commercial.

Other advantages of the apparatus 10 include:
Hermetic, easy to implement system with low maintenance, few controls, and safe for the user.
Reliable process that does not require any specific assistance.
Gravity based, low energy cost.
Simple system, compact, easy to install (can be above ground or buried), requires minimal space. For example can be installed above ground in locations where digging is not possible.
Natural system, no odors, long lasting, low maintenance.
Very low sludge production.
Can be manufactured using long lasting, low cost plastic material.
Can be sized to process multi-housing projects (most systems are designed for single house use).
Can process waste from installation with in-sink garbage disposers (not all system can claim this).
A leaching bed is not required.
No contamination of nearby wells
Can be installed in areas with high water tables (near lakes or rivers for example). Usually, these systems are equipped with holding tanks that require pumping when full.
Eliminates costly soil analysis requirements.
Can process farm waste such as hog slurry.
Can be easily coupled to heat recovery systems.
Can be easily complemented by additional standard systems like UV, fine filtration, or water disinfection to produce lower bacterial counts.

### OTHER EMBODIMENTS

From the foregoing description, it will be apparent to one of ordinary skill in the art that variations and modifications may be made to the invention described herein to adapt it to various usages and conditions. Such embodiments are also within the scope of the present invention.

All publications mentioned in this specification are hereby incorporated by reference

### OTHER EMBODIMENTS

While specific embodiments have been described, those skilled in the art will recognize many alterations that could be made within the spirit of the invention, which is defined solely according to the following claims:

We claim:

1. An anaerobic reactor for purifying waste water, the reactor comprising:
a) a chamber having a first water inlet for receiving a volume of waste water and a first water outlet connectable to a biofilter; and
b) a plurality of interdigitated baffle walls arranged in the chamber so as to define a water passageway between the first water inlet and the first water outlet.

2. The reactor, according to claim 1, in which the chamber includes a chamber roof and a chamber floor, a first plurality of spaced apart baffle walls extending away from the chamber floor and a second plurality of spaced apart baffle walls depending away from the chamber roof.

3. The reactor, according to claim 1, in which the interdigitated baffle walls define a plurality of compartments in fluid communication with each other.

4. The reactor, according to claim 2, in which the chamber roof includes three spaced apart baffle walls and the chamber floor includes three spaced apart baffle walls, the baffle walls defining three compartments in fluid communication with each other.

5. The reactor, according to claim 1, in which the baffle walls support anaerobic bacterial growth thereon.

6. The reactor, according to claim 1, in which the biofilter is located downstream of the first water outlet for receiving water from the water passageway.

7. The reactor, according to claim 1, in which the biofilter includes a conduit located exterior of the chamber, the conduit having a second water inlet and a second water outlet, the second water inlet being connected to the first water outlet.

8. The reactor, according to claim 7, in which an air supply is connected to the conduit for supplying air into the conduit, the air being supplied in an amount sufficient to support aerobic growth of bacteria.

9. The reactor, according to claim 7, in which the conduit includes an amount of a filtration medium disposed therein.

10. The reactor, according to claim 8, in which the air supply supplies a volume of microbubbles into the conduit.

11. The reactor, according to claim 8, the air supply is heatable.

12. The reactor, according to claim 7, in which the conduit is serpentine.

13. The reactor, according to claim 7, in which the conduit surrounds the chamber and is disposed orthogonal to the ground.

14. The reactor, according to claim 7, in which a recycling pump is connected to the second water outlet for re-injecting the water into the conduit.

15. The reactor, according to claim 1, in which a septic tank is connected to the first water inlet.

16. The reactor, according to claim 15, in which a recycling pump is connected to the septic tank.

17. The reactor, according to claim 14, in which the recycling pump is connected to the chamber.

18. The reactor, according to claim 14, in which the recycling pump is connected to the biofilter.

19. The reactor, according to claim 7, in which the biofilter is located in a container away from the chamber.

20. The reactor, according to claim 1, in which the baffle walls control the transit time of waste water through the chamber.

21. A biofilter for use with an anaerobic reactor, the biofilter comprising:
a) a conduit having a water inlet and a water outlet, the water inlet being connectable to the anaerobic reactor;
b) an air supply connected to the conduit for supplying air into the conduit, the air being supplied in an amount sufficient to support aerobic growth of bacteria in the conduit; and
c) an amount of a filtration medium disposed in the conduit for filtering particulate material.

22. The biofilter, according to claim 21, in which the conduit is serpentine.

23. An apparatus for purifying waster water, the apparatus comprising:
a) an anaerobic reactor including a chamber having a first water inlet for receiving a volume of waste water and a first water outlet connected to a biofilter;
b) a plurality of interdigitated baffle walls arranged in the chamber so as to define a water passageway between the first water inlet and the first water outlet;
c) an aerobic biofilter connected to the first water outlet, the biofilter being a conduit having an amount of a filtration medium located therein; and
d) an air supply connected to the conduit for supplying air into the conduit, the air being supplied in an amount sufficient to support aerobic growth of bacteria.
